(19) United States
(12) Patent Application Publication
(10) Pub. No.: US 2007/0159278 A1
(43) Pub. Date: Jul. 12, 2007

(54) Coaxial cable

(75) Inventor: Raoul Aemisegger, Rorschacherberg (CH)

Correspondence Address: THE WEBB LAW FIRM, P.C., 700 KOPPERS BUILDING, 436 SEVENTH AVENUE, PITTSBURGH, PA, 15219, US

(73) Assignee: HUBER AG, Herisau (CH)

(21) Appl. No.: 10/585,901

(22) PCT Filed: Oct. 18, 2004
(86) PCT No.: PCT/CH04/00628

§ 371 Date: Jul. 13, 2006

(30) Foreign Application Priority Data
Jan. 19, 2004 (CH) 00068/04

(51) Int. Cl. H01P 3/06

(52) U.S. Cl. 333/243

(57) ABSTRACT

Disclosed is a coaxial cable that includes a central inner conductor, a dielectric that coaxially surrounds the inner conductor, a band-shaped first outer conductor which is wound around the dielectric in a helical and overlapping manner, a woven high-tensile outer conductor that coaxially encloses the first outer conductor, and a sleeve which coaxially envelops the high-tensile outer conductor. Constant transmission characteristics of the cable can be ensured by providing additional sheathing for mechanically and/or electrically stabilizing the first outer conductor within the coaxial cable.

### TECHNICAL FIELD

The present invention relates to the field of coaxial cables. It concerns a coaxial cable, in particular for high frequencies in the range from 1 GHz to 65 GHz, according to the precharacterizing clause of claim 1.

### PRIOR ART

Coaxial cables, which comprise a central inner conductor and an outer conductor, surrounding the inner conductor, in a coaxial arrangement, have long been used for the transmission of high and extra-high frequencies in the MHz and GHz range. The space between the inner conductor and the outer conductor is filled with a dielectric. The conductor arrangement is sheathed on the outside with a sleeve. The outer conductor is often formed by a wire braid, in order to give the cable the desired flexibility and, in particular, also the necessary axial tensile strength.

Since, on account of its structure, a wire braid is not completely impermeable at extra-high frequencies, and consequently the associated coaxial cable is not completely shielded at these frequencies, in some cases a further coaxial outer conductor comprising an electrically conducting strip, for example a thin metal strip, that is helically wound in the longitudinal direction of the cable is provided between the outer side of the dielectric and the braided outer conductor. The structure of such a known coaxial cable is shown in side view and in cross section in FIGS. 1 and 2, respectively. For the sake of clarity, the diameter variations of the various layers of the cable are not shown to scale here.

The known coaxial cable 10 that is represented in FIGS. 1 and 2 has a central inner conductor 11 comprising a silver-plated Cu wire, which is enclosed by a dielectric 12, which consists for example of an extruded (unsintered, expanded) LD-PTFE (low-density polytetrafluoroethylene). Helically wound around the dielectric 12, as the first outer conductor 13, is a silver-plated Cu strip, which, by adequate overlapping of the windings 16, forms a uninterruptedly continuous conductor. Arranged around the first outer conductor 13 as a second outer conductor 14 is a tubular braid of silver-plated Cu wire, which is in direct electrical contact with the first outer conductor over the entire length of the cable and so, together with the first outer conductor, electrically represents a single outer conductor. The outer termination is formed by an electrically insulating sleeve 15, which encloses the second outer conductor 14 and preferably consists of an extruded fluoroethylene propylene (FEP). Such a coaxial cable is available on the market, for example, from the applicant under the type designation SUCOFLEX® 104. Instead of the solid silver-plated Cu wire as the inner conductor 11, it is also quite possible for a stranded or litz-like inner conductor comprising a number of thin individual wires, for example silver-plated Cu wires, to be used as the inner conductor 11. The coaxial cable in this form is offered by the applicant under the type designation SUCOFLEX® 104P. Furthermore, since the helically wound strip already provides a complete outer conductor, it is possible to provide instead of the second outer conductor of wire braid a braid of nonconducting synthetic fibers, for example of aramid, which then only provides the necessary tensile strength of the cable. There is then only one (wound, strip-like) outer conductor, which is surrounded by the aramid braid as means for producing the axial tensile strength.

A disadvantage of this known coaxial cable is that the expanded PTFE as the dielectric 12 is not completely hard and the braid of the second outer conductor 14, or the means of providing tensile strength, does not exert a very great contact pressure on the inner layers of the cable. Under flexure and torsion of the cable, the tightly bound first outer conductor 13 must open easily and no longer has optimum contact with the dielectric 12. It is then no longer a perfectly closed outer conductor, which results in reduced screening attenuation and possibly also instability in the transmission properties of the cable.

JP-A-20057863 discloses a coaxial cable in which a dielectric (5) which is made up of an inner layer of a wound tetrafluoroethylene strip (3) and an outer layer (4) of thin-walled FEP is arranged between the inner conductor and the wound outer conductor. A wire braid is not provided there.

JP-A-11339570 discloses a coaxial cable with a double outer conductor comprising an inner, wound strip and an outer wire braid. The two outer conductors are separated from each other by a thin, wound insulating strip. Since, like the inner outer conductor, the insulating strip is formed as a wound strip, it has the same weaknesses with respect to mechanical loads of the cable and can contribute virtually nothing to the mechanical stabilization of the inner outer conductor.

Finally, a coaxial cable with an inner conductor, a dielectric surrounding the inner conductor and an outer conductor surrounding the dielectric is disclosed in US-A-20030168240. Arranged between the dielectric and the outer conductor is a metallized plastic strip, which with its outer metallization forms an inner outer conductor and is helically wound around the dielectric. The disadvantages under mechanical loading are the same as in the case of the aforementioned coaxial cable of the SUCOFLEX® 104 type.

### SUMMARY OF THE INVENTION

The object of the invention is to provide a coaxial cable which is suitable in particular for extra-high frequencies in the range between 1 GHz and 65 GHz and, while at the same time having a simple structure, is distinguished by consistently good transmission properties even under recurrent mechanical loading.

The object is achieved by the features of claim 1 in their entirety. The essence of the invention is to provide additional stabilizing means within the coaxial cable for the mechanical and or electrical stabilization of the first outer conductor. These additional stabilizing means allow reliable avoidance of a deterioration in the shielding properties of the wound (bound) first outer conductor on account of mechanical loading of the cable.

A preferred configuration of the coaxial cable according to the invention is characterized in that the additional stabilizing means are arranged between the first outer conductor and the means of providing tensile strength, that the additional stabilizing means comprise a coaxial sheathing of the first outer conductor, which consists either of an electrically insulating plastic, in particular a fluorinated ethylene propylene (FEP), or of an electrically conducting plastic, and that the sheathing is formed continuously in the longitudinal direction of the cable and is produced in particular by extrusion around the first outer conductor.

Outstanding stabilization is already achieved in this case if the wall thickness of the sheathing lies in the region of 1/10 mm.

According to a further preferred configuration, the remaining structure of the coaxial cable is distinguished by the fact that the inner conductor is formed as a silver-plated Cu wire, which preferably has a diameter in the region of 1 mm, or as a stranded wire, in particular comprising silver-plated Cu wires, that the dielectric consists of an extruded plastic, in particular a low-density polytetrafluoroethylene (PTFE), and has a wall thickness in the region of 1 mm, that the means of providing tensile strength are formed as a second outer conductor, the means of providing tensile strength being braided in particular from silver-plated Cu wires with a minimum coverage of 50%, and the diameter of the Cu wires being approximately 1/10 mm, or the means of providing tensile strength being braided from electrically insulating synthetic fibers, in particular aramid fibers, and that the sleeve consists of an electrically insulating plastic, in particular an extruded fluorinated ethylene propylene (FEP), and preferably has a wall thickness of approximately 2/10 mm.

The first outer conductor preferably comprises a silver-plated Cu strip, has a width of approximately 2.4 mm and a thickness of approximately 6/100 mm and is wound with an overlap of at least 40% to form the first outer conductor.

In the case of a pre-assembled coaxial cable which is of a given length and is equipped at its ends with elements for producing an electrical connection, and in which the means of providing tensile strength are formed as a second outer conductor, the first and second outer conductors are connected to each other in an electrically conducting manner, at least at the ends of the coaxial cable.

### BRIEF EXPLANATION OF THE FIGURES

The invention is to be explained in more detail below on the basis of exemplary embodiments in conjunction with the drawing, in which:

FIG. 1 shows the structure of a coaxial cable according to the prior art in a side view, the diameter variations between individual layers not been shown to scale;

FIG. 2 shows the cross section through the coaxial cable from FIG. 1;

FIG. 3 shows the structure of a coaxial cable according to a preferred exemplary embodiment of the invention in a representation comparable to FIG. 1; and

FIG. 4 shows the cross section through the coaxial cable from FIG. 3.

### WAYS OF IMPLEMENTING THE INVENTION

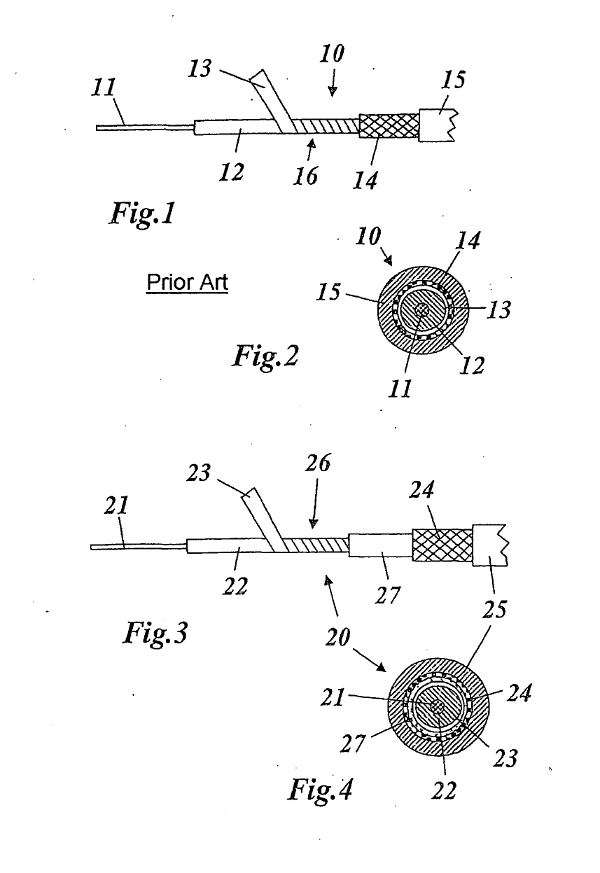

In FIG. 3, the structure of a coaxial cable according to a preferred exemplary embodiment of the invention is shown in a representation comparable to FIG. 1. The coaxial cable 20 has a structure which comprises, in coaxial arrangement, in a sequence from inside to outside, a central inner conductor 21, a dielectric 22, surrounding the inner conductor 21, a strip-like first outer conductor 23, helically wound around the dielectric 22, a sheathing 27, enclosing the first outer conductor 23, means of providing tensile strength 24 in the form of a second, braided outer conductor and a sleeve 25, enclosing the means of providing tensile strength or the second outer conductor 24. The sheathing 27 is an extruded thin (one-piece) sheath which is continuous in the longitudinal direction of the cable, lies snugly against the first outer conductor 23 and prevents the windings 26 of the first outer conductor 23 from slipping or opening under mechanical loading of the coaxial cable. By the sheathing 27, an inwardly directed force is exerted on the strip of the first outer conductor 23 and, in addition, the axial freedom of movement of the strip under flexure of the coaxial cable 20 is restricted. This achieves the effect that the individual transfer resistances from one strip layer to the next, i.e. between the individual windings 26, is kept largely constant, and so the entire contact resistance of the first outer conductor 23 is stabilized. As a consequence of this, the shielding effect of the strip can be increased and, finally, clear positive effects on the electrical stability of the entire cable are obtained.

Dimensions and materials of a coaxial cable according to the invention, given by way of example, are listed below:

inner conductor 21: solid, silver-plated Cu wire with a diameter of 1.1 mm (or stranded wire with comparable dimensions)

dielectric 22: extruded LD-PTFE with an outside diameter of 3.2 mm

outer conductor 23: silver-plated Cu strip with a width of 2.4 mm and a thickness of 0.06 mm; helically wound with 40% overlap; outside diameter of 3.4 mm

sheathing 27: solid extruded FEP with an outside diameter of 3.7 mm

outer conductor 24: braid of soft silver-plated Cu wire; individual wire diameter of 0.1 mm; 90% coverage; outside diameter of 4.1 mm

sleeve 25: solid extruded FEP with an outside diameter of 4.5 mm.

The structure of the coaxial cable according to the invention can be readily used for cables with outside diameters in the range from approximately 2 to 8 mm. The individual dimensions must then be correspondingly adapted. In the case of the continuously produced cable according to the exemplary embodiment of the invention, the two outer conductors 23 and 24 are first electrically insulated from each other by the insulating sheathing 27. If a coaxial cable of finite length is assembled and provided with plug-in connectors or other connecting elements at the ends, it must be ensured that the two outer conductors 23, 24 are electrically connected to each other in the end regions. This may take place for example by a special configuration of the plug-in connectors or connecting elements. It is also possible, however, to work with an electrically conducting sheathing 27. There is then no longer any insulation of the two outer conductors 23, 24 from each other.

### LIST OF DESIGNATIONS

10,20 coaxial cable
11,21 inner conductor
12,22 dielectric
13,23 outer conductor (bound)
14 outer conductor (braided)
15,25 sleeve
16,26 winding
24 means of providing tensile strength (outer conductor)
27 sheathing

1-16. (canceled)

17. A coaxial cable comprising:
a central inner conductor;
a dielectric coaxially enclosing the inner conductor;
a strip-like first outer conductor wound around the dielectric in a helical and overlapping manner;
braided means of providing tensile strength coaxially enclosing the first outer conductor;
a sleeve coaxially sheathing the braided means of providing tensile strength; and
stabilizing means provided within the coaxial cable for the mechanical and or electrical stabilization of the first outer conductor.

18. The coaxial cable as claimed in claim 17, wherein the stabilizing means is/are arranged between the first outer conductor and the braided means of providing tensile strength.

19. The coaxial cable as claimed in claim 18, wherein the stabilizing means comprises a coaxial sheathing of the first outer conductor.

20. The coaxial cable as claimed in claim 19, wherein the coaxial sheathing is comprised of an electrically insulating plastic.

21. The coaxial cable as claimed in claim 20, wherein the electrically insulating plastic is a fluorinated ethylene propylene (FEP).

22. The coaxial cable as claimed in claim 19, wherein the coaxial sheathing is comprised of an electrically conducting plastic.

23. The coaxial cable as claimed in claim 20, wherein the coaxial sheathing is formed continuously in the longitudinal direction of the cable and is produced by extrusion around the first outer conductor.

24. The coaxial cable as claimed in claim 22, wherein the coaxial sheathing is formed continuously in the longitudinal direction of the cable and is produced by extrusion around the first outer conductor.

25. The coaxial cable as claimed in claim 19, wherein the wall thickness of the coaxial sheathing lies in the region of 1/10 mm.

26. The coaxial cable as claimed in claim 17, wherein the inner conductor is formed as a silver-plated Cu wire having a diameter in the region of 1 mm.

27. The coaxial cable as claimed in claim 17, wherein the inner conductor is formed as a stranded wire comprised of silver-plated Cu wires.

28. The coaxial cable as claimed in claim 17, wherein the dielectric is comprised of an extruded plastic.

29. The coaxial cable as claimed in claim 28, wherein the extruded plastic is a low-density polytetrafluoroethylene (PTFE) having a wall thickness in the region of 1 mm.

30. The coaxial cable as claimed in claim 17, wherein the first outer conductor comprises a silver-plated Cu strip having a width of approximately 2.4 mm and a thickness of approximately 6/100 mm.

31. The coaxial cable as claimed in claim 30, wherein the Cu strip is wound with an overlap of at least 40% to form the first outer conductor.

32. The coaxial cable as claimed in claim 17, wherein:
the braided means of providing tensile strength is/are formed as a second outer conductor;
the braided means of providing tensile strength is/are braided from silver-plated Cu wires with a minimum coverage of 50%; and
the diameter of the Cu wires is approximately 1/10 mm.

33. The coaxial cable as claimed in claim 17, wherein the braided means of providing tensile strength is/are braided from electrically insulating synthetic fibers.

34. The coaxial cable as claimed in claim 33, wherein the synthetic fibers are aramid fibers.

35. The coaxial cable as claimed in claim 17, wherein the sleeve is comprised of an electrically insulating plastic.

36. The coaxial cable as claimed in claim 35, wherein the electrically insulating plastic is extruded fluorinated ethylene propylene (FEP) having a wall thickness of approximately 2/10 mm.

37. The coaxial cable as claimed in claim 17, wherein the coaxial cable is of a given length, the braided means of providing tensile strength is/are formed as a second outer conductor, the coaxial cable is equipped at its ends with elements for producing an electrical connection, and the first and second outer conductors are connected to each other in an electrically conducting manner, at least at the ends of the coaxial cable.
